(19) United States
(12) Patent Application Publication
(10) Pub. No.: US 2026/0085662 A1
(43) Pub. Date: Mar. 26, 2026

(54) LUBRICATION RING, WIND TURBINE GEARBOX AND METHOD OF ASSEMBLY THEREOF

(71) Applicant: Envision Energy Co., Ltd, WUXI (CN)

(72) Inventors: Ralf Rueschoff, Dortmund (DE); Matthias Walkowiak, Dortmund (DE); JoergenDitlev Christensen, Dortmund (DE)

(73) Assignee: ENVISION ENERGY TECHNOLOGY PTE LTD., WUXI (CN)

(21) Appl. No.: 19/409,827

(22) Filed: Dec. 5, 2025

Related U.S. Application Data
(63) Continuation of application No. PCT/CN2023/099886, filed on Jun. 13, 2023.

(51) Int. Cl. F03D 80/70; F03D 15/10; F16H 57/04

(52) U.S. Cl. CPC F03D 80/707; F03D 15/101; F16H 57/0423; F16H 57/0486; F05B 2230/60; F05B 2260/40311; F05B 2260/98

(57) ABSTRACT

The present invention relates to a lubrication ring, a wind turbine gearbox, a method of assembly thereof and a wind turbine. The lubrication ring is formed by a number of ring segments that are positioned relative to each other in the circumference direction. The ring segments each have a first connection element and a second connection element, which are spaced apart to form a gap that takes up the thermal expansion of the ring segments. The lubrication ring forms at least one fluid channel for transferring lubrication fluid between a first gearbox part and a second gearbox part positioned relative to each other. Each ring segment has at least one mounting point for securing the ring segment to the first or second gearbox part and at least one first opening for guiding the lubrication fluid through the lubrication ring.

### CROSS REFERENCE TO RELATED APPLICATION

This application is a continuation of International Application No. PCT/CN2023/099886, filed on Jun. 13, 2023, titled “A lubrication ring, a wind turbine gearbox, and a wind turbine and a method of assembly thereof”, the entire contents of which are incorporated herein by reference.

### FIELD OF THE INVENTION

The present invention relates to a lubrication ring for wind turbine gearboxes, preferably planetary gears, where the lubrication ring is configured to be positioned relative to a first gearbox part and a second gearbox part, the lubrication ring extending in a circumference direction and having a local radial thickness and a local axial height. The lubrication ring is shaped to transfer a lubrication fluid between the first and second gearbox parts via lubrication paths within the gearbox parts.

The present invention also relates to a wind turbine gearbox comprising the lubrication ring, a wind turbine and a method of assembling thereof.

### BACKGROUND OF THE INVENTION

It is known that the wind turbine comprises a gearbox arranged between the rotor and the generator for converting a low speed, high torque input from the rotor into a high or medium speed, low torque output for the generator. The gearbox comprises a plurality of gear stages, each rotating on sliding or roller bearings arranged on the respective pinions or shafts located within the gearbox.

The gearbox is coupled to an external lubrication system for circulating oil through the gearbox. The lubrication oil is transferred to the respective bearings and/or gear meshes via lubrication paths for assuring lubrication between the contacting surfaces while cooling the gears and/or the bearings. A gap is formed between the stationary gearbox housing and the rotating planet carriers to reduce, or even avoid, wear during operational and design conditions. A known problem is that the gap allows for oil leakage and pressure drop in the circulating oil.

Typically, a continuous lubrication ring is arranged between the stationary gearbox housing and on the rotating planet carrier for sealing off the gap between the gearbox housing and the planet carrier. The lubrication ring forms a channel for guiding oil through the gap. A known problem is that the lubrication ring expands radially and axially during heating. This may cause the lubrication ring to close off the gap, or it may get stuck at the outside while opening the gap on the inside, which results in the lubrication ring to wear out and thereby increasing the oil leakage.

EP 3056763 B1 discloses a wind turbine gearbox with a lubrication ring assembly arranged between the gearbox housing and the planetary gear. The lubrication ring assembly comprises two rings arranged separately relative to each to form a continuous opening or a plurality of openings in between. The ring may be made of rubber or a polymer material.

EP 1488139 B1 discloses a U-shaped ring arranged between the planet carrier and the sun gear, where the ring is fixed relative to the planet carrier. The U-shaped ring engages with an opposite facing stem or U-shaped ring on the sun gear. The ring may be made of polyamide plastic material.

EP 3094913 B1 discloses a X-shaped ring forming two channels separated by an intermediate panel, in which a plurality of openings is arranged. The legs of each channel have a curved profile so the thickness at the opened end is larger than the thickness at the intermediate panel. Thereby, the legs press against the contacting side surfaces of the respective grooves. The X-shaped ring is made of a plastic material or metal.

Another solution is disclosed in EP 1767814 B1 where the gearbox comprises an integrated lubrication path coupled to an oil lubrication supply. A continuous U-shaped ring is fixed to the planet carrier and extends into a groove formed in the gearbox housing. It is stated that the ring is sealed relative to the groove by means of a labyrinth structure, but no further details about this structure are disclosed. The drawings thereof only illustrate that the groove is formed as a U-shaped channel element attached to the gearbox housing.

Lubrication rings can also be used in direct-drive wind turbines where the lubrication ring is arranged around a rotatable rod operated at high speeds. An example of such configuration is disclosed in CN 112502912 A, where the lubrication ring forms an internal chamber, and lubrication oil is poured into the chamber via a plug at the outside. The lubrication oil is flowing through the inside of the ring via leak nozzles.

Thus, there is a need for an improved lubrication ring that seals off the gap between two gearbox parts, where a rotating movement is performed between the two gearbox parts.

### Object of the Invention

One object of the present invention is to solve the problems of the abovementioned prior art.

One object of the present invention is to provide a lubrication ring that reduces, or even avoids, wear while reducing the oil leakage.

### Description of the Invention

One object of the invention is achieved by a lubrication ring for a wind turbine gearbox, preferably a planetary gear box, where the lubrication ring is configured to be positioned in a first gap formed between a first gearbox part and a second gearbox part, the lubrication ring extending in a circumference direction and having a cross-sectional profile with a local radial thickness and a local axial height, the lubrication ring forming at least one fluid channel extending in the circumference direction for transferring a lubrication fluid between the first and second gearbox parts, the fluid channel being connected to at least one first opening arranged in a transverse wall of the lubrication ring for facilitating the flow of lubrication fluid through the lubrication ring, wherein the lubrication ring comprises a number of ring segments, each having a local first end and a local opposite second end in the circumference direction, the first end of one ring segment is adapted to be arranged relative to the second end of an adjacent ring segment.

This provides a lubrication ring for wind turbine gearboxes that allows wear on the gearbox parts to be reduced to a minimum, or even avoids wear. The lubrication ring is configured to be positioned in a gap (ref. first gap) formed between two gearbox parts, between which a relative rotational movement is performed during operation or idling. The lubrication ring is shaped to substantially seal the gap and reduce the oil leakage and pressure drop between the two gearbox parts. The lubrication ring has a segmented configuration, which allows faster and cheaper production and saves waste material.

The lubrication ring extends in a circumference direction and further in a radial direction and an axial direction. The lubrication ring has a first axial end and an opposite facing second axial end, and further a first radial side and an opposite facing second radial side. The axial direction of the lubrication ring is parallel to the axial direction of the gearbox, while the radial direction of the lubrication ring is perpendicular to the axial direction.

According to one embodiment, when assembled, a second gap is formed between the first end of the one ring segment and the second end of the adjacent ring segment, where the ring segments are adapted to expand towards each other in the circumference direction, when heated.

The present lubrication ring is formed by a number of ring segments, each having an angular length in the circumference direction measured between a local circumferential end (ref. first end) and an opposite local circumferential end (ref. second end). The number of ring segments may depend on the diameter of the lubrication ring and/or the configuration of the lubrication path system for the gearbox. The first end of one ring segment may be positioned relative to the second end of an adjacent ring segment, and vice versa, during assembly.

A gap (ref. second gap) may be formed between the first end of said one ring segment and the second end of said adjacent ring segment. The ring segments may expand or contract in at least the circumference direction, when heated or cooled by the circulating lubrication fluid. The width of the gap in the circumference direction may be selected to correspond to the estimated heat expansion, e.g., at maximum operating temperature of the lubrication fluid. The number and/or width of gaps may depend on the number of ring segments.

The gaps between the individual ring segments will thus take up most of the thermal expansion, as the diameter of the segmented lubrication ring will follow the thermal expansion of the ring segments in the radial direction. Whereas in conventional, continuous lubrication rings the thermal expansion will cause the lubrication ring to directly expand from one diameter to a larger diameter. This causes added wear on the contacting surfaces, or even the lubrication ring getting stuck.

The present lubrication ring, and thus ring segments, forms at least one fluid channel extending in the circumference direction. The fluid channel is shaped to guide a lubrication fluid along the lubrication ring. A transverse wall extending between two radial side walls and comprising a number of openings (ref. first openings) for guiding the lubrication fluid through the lubrication ring. The number of openings may depend on the diameter of the lubrication ring and/or the configuration of the lubrication path system in the gearbox. This allows the lubrication fluid to be transferred between the first and second gearbox parts.

In one embodiment, the first end has a first connection element and the second end has a second connection element, where the first and second connection elements are adapted to engage each other, when assembled.

The first end of one ring segment may be configured to engage with the second end of an adjacent ring segment, and vice versa. The first end may have a first connection element and the second end may have a second connection element. The first and second connection elements may be shaped to be brought into engagement during assembly. The first connection element may have a male profile while the second connection element may have a female profile, or vice versa. This facilitates the correct orientation and alignment of the ring segments during assembly.

In one embodiment, the first and second connection elements together form a labyrinth seal in the axial direction, the radial direction and/or the circumference direction.

The first and second connection elements may also act as first and second sealing elements, respectively. The first and second sealing elements may interlock to form a seal at the gap, such as a multistage or contactless seal. Preferably, the first and second connection elements may form a labyrinth seal extending in the axial direction, the radial direction and/or the circumference direction. The labyrinth seal may take up thermal expansion of the adjoining ring segments. The cross-sectional profile of these first and second sealing elements, e.g., the labyrinth seal, may depend on the cross-sectional profile of the lubrication ring and the first and second gearbox parts. This reduces the leakage and allows for a relative constant fluid pressure within the lubrication channel.

However, other sealing profiles may also be used to seal the gaps between ring segments. For example, a lip seal, a tongue-groove seal, a male-male seal, or a female-female seal may be used.

In one embodiment, the ring segments have a U-, H- or X-shaped cross-sectional profile.

In the present invention, the cross-sectional profile of the ring segments may be defined at the lubrication fluid transferring openings (ref. first openings).

Each ring segment may have U-shaped cross-sectional profile where the two opposite facing radial side walls and the transverse wall together form the lubrication channel. Here, the transverse wall may further form an end surface at the first axial end of the ring segment. The fluid channel may be arranged at the second axial end of the ring segment. Thereby, the U-shaped ring segment may have a stiff cross-sectional profile. This also allows for easy manufacture process of the ring segments.

Each ring segment may also have H-shaped cross-sectional profile. Here, the ring segment further comprises an interface for at least partly receiving a nozzle or orifice element. The interface may be shaped as a continuous recess arranged in the first axial end, which may be shaped to receive at least a part of the nozzle or orifice elements. The interface may also be shaped as individual recesses arranged in the first axial end, each of which may be shaped to receive at least a part of a particular nozzle or orifice element. The opening in the transverse wall may extend between the lubrication channel and this recess. Hereby, the H-shaped ring segment may have a uniform radial outer thickness and a lower stiff cross-sectional profile. However, a more complex manufacture process may be required compared to the U-shaped ring segment.

Each ring segment may also have X-shaped cross-sectional profile. Here, the ring segment may have a varying radial outer thickness, where the minimum radial outer thickness may be measured at the radial centre line of the ring segment. The maximum radial outer thickness may be measured between the radial centre line and the first or second axial ends. Hereby, the X-shaped ring segment may have a lower stiff cross-sectional profile. However, a more complex manufacture process may be required compared to the U-shaped ring segment.

The ring segments may have rounded or bevelled corners, edges or wall thickness to reduce wear and reduce the overall contact surface area with the respective gearbox parts.

In one embodiment, the lubrication ring further comprises at least one mounting point for securing the lubrication ring to the first or second gearbox part, preferably the lubrication ring is adapted to move relative to the at least one mounting point in the circumference direction, when expanding.

Each ring segment may be secured to the first or second gearbox part at a number of mounting points. The mounting points may differ from the positions of the nozzle or orifice elements. The ring segments may be fixed to the gearbox part using fastening elements, such as bolts, screws, pins or the like. This allows the ring segments to be secured to one of the gearbox parts while the ring segments may slide relative to the other gearbox part.

In one embodiment, the mounting point comprises an oblong opening in the transverse wall adapted to receive a fastening element for securing the lubrication ring.

The mounting points may preferably be shaped as openings (ref. second openings) in the transverse wall. These openings may be oblong openings. A fastening element may be inserted into each mounting point for securing the ring segments to the gearbox part. The mounting points may hold the ring segments in place in the circumferential direction and allow the ring segments to expand or contract thermally. The positions of the nozzle or orifice elements may act as coordinate origins from which the thermal expansion may take place into both circumferential directions.

In one embodiment, the ring segments are made of a plastic material, a ferrous metal or metal alloy, or a non-ferrous metal or metal alloy.

The ring segments may be made of a plastic material, such as polyamide, silicone, EPDM, rubber or other plastic materials. The ring segments may also be made of a ferrous or non-ferrous metal, or a ferrous or non-ferrous metal alloy. However, other suitable materials may also be used.

The softness (or flexibility) of the ring segments may be selected based on the desired contact pressure and wear on the gearbox parts. Selecting a soft material for the ring segment may reduce the contact pressure on the respective gearbox parts. A soft material may also allow for a reduced width of the gap (ref. first gap) between the gearbox parts without too high of wear in case of contact.

One object of the invention is also achieved by a wind turbine gearbox, comprises a first gearbox part and a second gearbox part, wherein a first gap is formed between the first and second gearbox parts, an internal or external lubrication system is connected to the first gap for circulating a lubrication fluid between the first gearbox part and the second gearbox part, wherein a lubrication ring as described above is positioned in the first gap.

This provides an improved wind turbine gearbox configuration that reduces wear and leakage between two gearbox parts between which a relative rotating motion is performed. The present lubrication ring has a segmented configuration, which allows majority of the thermal expansion to be performed in the circumference direction. Thereby allowing for a smaller gap between the two gearbox parts while reducing the wear if the sliding surfaces are contacting.

The lubrication ring is fluid communication with a lubrication path system within the gearbox. At least one first lubrication path feeds lubrication fluid to the lubrication ring, where the lubrication fluid is guided through the ring segments and into at least one second lubrication path. The second lubrication paths guide the lubrication fluid to the respective rotating gearbox parts. This ensures that the lubrication fluid is transferred to the gear meshes and/or the planet carrier bearings.

A lubrication system comprising at least a pump and a lubrication reservoir may be coupled to the lubrication path system for circulating a lubrication fluid, such as lubrication oil, within at least the gearbox. The lubrication system may further comprise one or more coolers, filters or other components for removing contaminants and heat from the lubrication fluid. One or more components of the lubrication system may be integrated into the gearbox, or they may be provided as external components coupled to the lubrication path system in the gearbox. This allows for better lubrication of the gearbox parts.

In one embodiment, the lubrication ring is secured to a gearbox housing or a planet carrier in the gearbox.

The ring segments may be secured to a first gearbox part while being able to slide relative to a second gearbox part. The first gearbox part may be stationary while the second gearbox part may rotate relative to the first gearbox part, or vice versa. Preferably, the first gearbox part may be a gearbox housing and the second gearbox part may be a planet carrier, or vice versa. Alternatively, the first and second gearbox parts may both rotate, where the first and second gearbox parts may rotate at different speeds. Preferably, the first gearbox part may be a first planet carrier or shaft and the second gearbox part may be a second planet carrier or shaft. This allows for an axial orientation of the lubrication ring and thus an axial transference of lubrication fluid.

In one embodiment, at least one fluid path is arranged within at least one of the first and second gearbox parts and further connected to the first gap, wherein a nozzle or orifice element is arranged at an opening of the at least one fluid path, the opening facing the first gap.

The first gearbox part may comprise a number of first lubrication paths connected to the gap between the two gearbox parts. The second gearbox part may also comprise a number of second lubrication paths further connected to the gap. Each of the first and second lubrication paths may comprise an opening (ref. third opening) arranged at the opposite facing axial end surfaces of the respective gearbox parts defining the gap. The ring segments may thus be positioned between these axial end surfaces.

A first groove may instead be formed in the axial end surface of one gearbox part, e.g., the first gearbox part, in the circumference direction. The first groove may be shaped to receive one axial end of ring segments, e.g., the first axial end, at least partly. The adjoining lubrication paths, e.g., the first lubrication paths, may be connected to the first groove, preferably at the bottom surface. Optionally, a nozzle or orifice element may be positioned within all or some of adjoining first lubrication paths at their respective openings. The nozzle or orifice element may be configured to compensate for any drop in fluid pressure in these lubrication paths.

Alternatively, a number of first recesses may be individually formed in the one axial end surface of the one gearbox part in the circumference direction. Each first recess may be connected to an adjoining lubrication path. The first recess may be shaped to receive the nozzle or orifice element at least partly. Each nozzle or orifice element may extend further into an interface at the corresponding axial end of the ring segments, as described earlier. The nozzle or orifice elements may thus be used to position the ring segments correctly on the one gearbox part.

Preferably, the first groove and optionally the first recess may be formed in the first axial end surface of the first gearbox part. Alternatively, the first groove and optionally the first recess may instead be formed in the second axial end surface of the second gearbox part.

A second groove may further be formed in the opposite axial end surface of the opposite gearbox part in the circumference direction. The second groove may be shaped to receive the opposite axial end of the ring segments at least partly. The adjoining lubrication paths may be connected to the second groove, preferably at the bottom surface. This allows the present lubrication ring to extend into grooves at least partly on both gearbox parts.

Preferably, the second groove may be formed in the second axial end surface of the second gearbox part. Alternatively, the second groove may instead be formed in the first axial end surface of the first gearbox part.

One object of the present invention is further achieved by a wind turbine comprising a wind turbine tower, a nacelle arranged on top of the wind turbine tower, and a rotor with at least one wind turbine blade arranged relative to the nacelle, where the rotor is connected to a gearbox which is further connected to a generator, wherein a lubrication system is coupled to a fluid path in at least the gearbox for circulating a lubrication fluid through the gearbox, wherein the gearbox is configured as described above.

The present gearbox configuration is suited for use in a wind turbine, such as in integrated drivetrains. However, the present lubrication ring and gearbox may also be used in other drivetrain configurations. The input of the gearbox may be connected to the rotor of the wind turbine. The output of the gearbox may be connected to the input of the rotor of the generator.

One object of the present invention is yet further achieved by a method of assembling a wind turbine gearbox, comprising:
providing a wind turbine gearbox comprising at least a first gearbox part and a second gearbox part,
positioning a first ring segment on one gearbox part, optionally in a first groove,
securing the first ring segment to the one gearbox part,
positioning at least a second ring segment relative to the first ring segment,
securing the second ring segment to the one gearbox part,
optionally, positioning further ring segments relative to the first or second ring segment and securing the further ring segments to the one gearbox part until the assembly of the lubrication ring is complete.

This provides a simple and quick method of assembling a wind turbine gearbox for use in a wind turbine. A first ring segment is initially positioned at the axial end surface of one gearbox part, e.g., the first or second gearbox part. The first ring segment is then secured to that gearbox part, e.g., using fastening elements as described earlier. These steps are then repeated until all ring segments are assembled and secured to form the complete lubrication ring.

Optionally, one or both gearbox parts may be pre-processed before the installation of the lubrication ring. For example, the first and second grooves and optionally first recesses may be machined into the respective axial end surfaces.

Once the assembly of the present lubrication ring is complete, the rest of the gearbox can be installed. For example, the opposite gearbox part is subsequently positioned and aligned relative to the one gearbox part to form the gap.

In one embodiment, prior to positioning one or more of the ring segments, a nozzle or orifice element is arranged at an opening of at least one fluid path in the one gearbox part, where the one or more ring segments are positioned relative to the at least one fluid path.

If needed, one or more nozzles or orifice elements may be positioned in one or more of the respective openings of the fluid paths before positioning the ring segments. Alternatively, the nozzles or orifice elements and ring segments may be installed in a combined step. This may compensate for any pressure drop in the lubrication paths.

In one embodiment, the method further comprises the step of positioning the first and second gearbox parts relative to each other so that a first gap is formed between the first and second gearbox parts, preferably the lubrication ring extends into a second groove in the opposite gearbox part.

Once the present lubrication ring is assembled and secured to the one gearbox part, then the opposite gearbox part is moved into position and secured to the gearbox, e.g., the gearbox housing. Alternatively, the opposite gearbox part is held in place and the one gearbox part is moved into position relative to the opposite gearbox part. This allows the rest of the gearbox to be assembled.

### DESCRIPTION OF THE DRAWING

The invention is described by example only and with reference to the drawings, wherein:

FIG. 1 shows an exemplary embodiment of a wind turbine,

FIG. 2 shows a blade shell of the wind turbine blade with a spar cap,

FIG. 3 shows a cross-section of the blade shell with two reinforcing webs,

FIG. 4 shows a cross-section of the gearbox with a first embodiment of a lubrication ring according to the invention,

FIG. 5 shows a cross-section of the gearbox with a second embodiment of the lubrication ring,

FIG. 6 shows a plurality of ring segments in an assembly configuration,

FIG. 7 shows the ring segments in an exploded configuration,

FIG. 8 shows the end interface between the first and second ring segments when assembled,

FIG. 9 shows the first and second ring segments of FIG. 8 before assembly,

FIG. 10 shows a cross-section of the first embodiment of the lubrication ring,

FIG. 11 shows a cross-section of the second embodiment of the lubrication ring,

FIG. 12 shows a cross-section of the third embodiment of the lubrication ring, and

FIG. 13 shows a cross-section of the gearbox with a third embodiment of the lubrication ring according to the invention.

In the following text, the figures will be described one by one, and the different parts and positions seen in the figures will be numbered with the same numbers in the different figures. Not all parts and positions indicated in a specific figure will necessarily be discussed together with that figure.

### DETAILED DESCRIPTION OF THE INVENTION

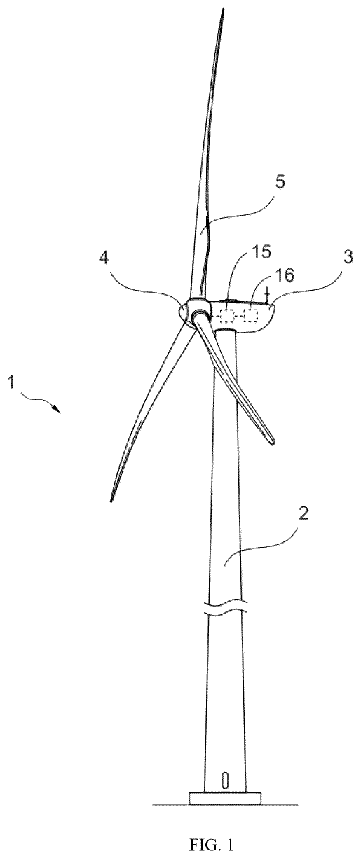

FIG. 1 shows an exemplary embodiment of a wind turbine 1 comprising a wind turbine tower 2, a nacelle 3 arranged on top of the wind turbine tower 2, and a rotor connected to a drive train in the nacelle 3. The rotor comprises a hub 4 and at least one wind turbine blade 5 connected to the hub 4. Here, three wind turbine blades 5 are shown, but the hub may be connected to more or less wind turbine blades.

The wind turbine 1 is here shown as an onshore wind turbine, but the wind turbine 1 may also be an offshore wind turbine 1.

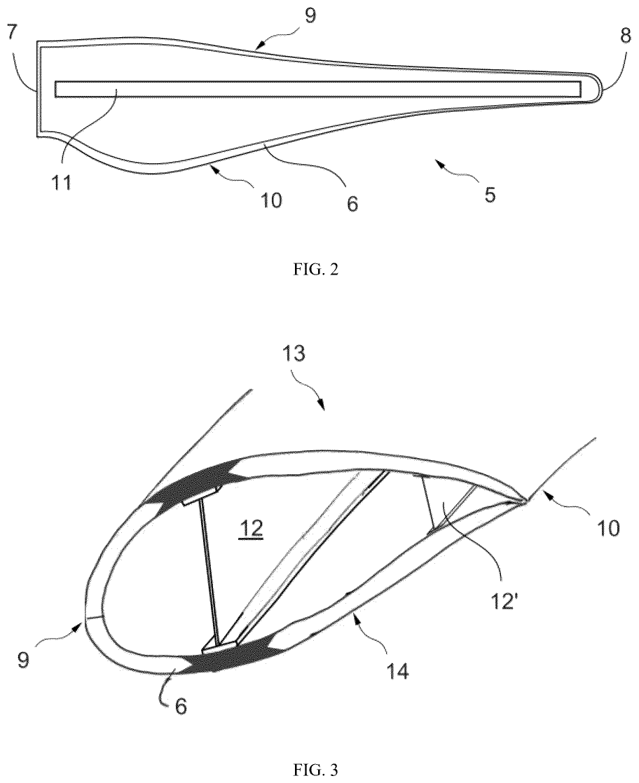

FIG. 2 shows a blade shell 6 of the wind turbine blade 5 with a spar cap 11 integrated or bonded to the aerodynamic portion of the blade shell 6. Here only one spar cap is illustrated but the blade shell may comprise more or less than one spar cap. The blade shell 6 may be a continuous blade shell or comprise two or more shell portions. The blade shell 6 extends from a first end 7, e.g., the root end, to a second end 8, e.g., the tip end, in a spanwise direction. The blade shell 6 further extends from a first edge 9, e.g., the leading edge, to a second edge 10, e.g., the trailing edge, in a chordwise direction.

FIG. 3 shows the blade shell 6 with two reinforcing webs 12, 12′ arranged within the blade shell 6. The blade shell 6 forms a pressure side 13 comprising an upper spar cap and a suction side 14 comprising a lower spar cap.

A shear web 12 extends between the upper and lower spar caps in a thickness direction. The shear web 12 is bonded or integrated with the upper and lower spar caps, respectively. Here only one shear web is illustrated but the wind turbine blade may comprise more or less than one shear web.

Optionally, one or more reinforcing webs 12′ are further arranged within the blade shell 6. The reinforcing webs 12′ are positioned at a distance from the leading edge 9 and/or the trailing edge 10. The reinforcing webs 12′ are bonded or integrated to the pressure and suction sides 13, 14 of the blade shell 6.

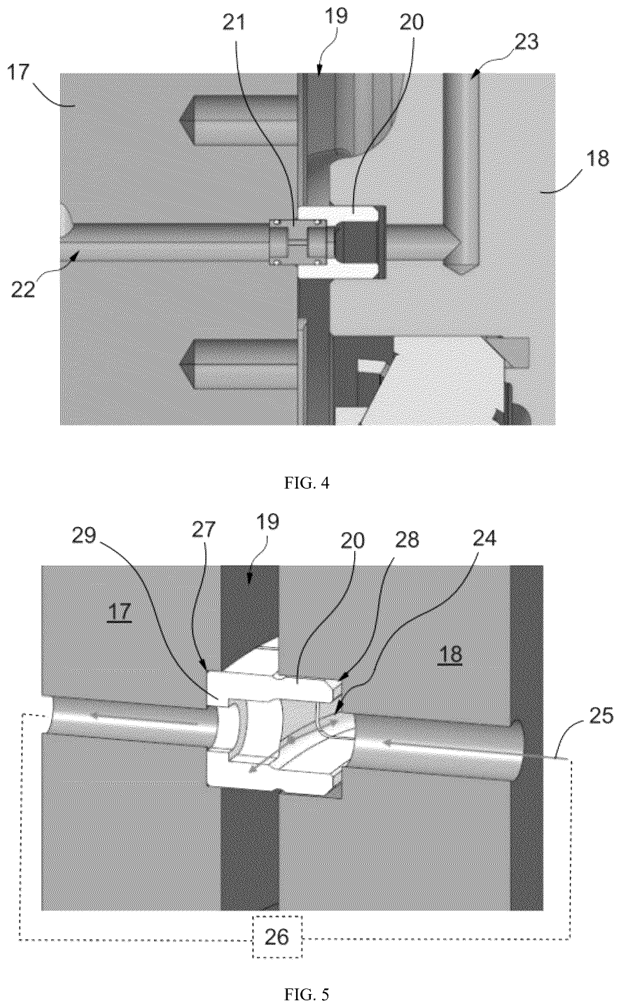

FIG. 4 shows a cross-section of a gearbox with a first embodiment of a lubrication ring according to the invention. The wind turbine 1 comprises a drivetrain arranged in the nacelle 3, wherein the drivetrain comprises at least a gearbox 15 and a generator 16. The gearbox input is connected to the rotor and the gearbox output is connected to the rotor input of the generator 16.

The gearbox 15 comprises a first gearbox part 17 and a second gearbox part 18 arranged relative to each other. A gap 19 is formed between opposite facing axial end surfaces of the respective gearbox parts 17, 18. Here, the second gearbox part 18 is a gearbox housing or a second rotatable gearbox part, e.g., a shaft or pinion. Here, the first gearbox part 17 is a planet carrier or a first rotatable gearbox part, e.g., another shaft or pinion.

A lubrication ring 20 is positioned in the gap 19 for sealing the gap 19 and reduce the oil leakage and pressure drop between the two gearbox parts during rotation. The first gearbox part 17 comprises an orifice element 21 arranged at the opening of a number of first fluid paths 22 connected to the gap 19. The second gearbox part 18 comprises a number of second fluid paths 23 connected to the gap 19.

FIG. 5 shows a cross-section of the gearbox 15 with a second embodiment of the lubrication ring 20. The lubrication ring 20 forms a fluid channel 24 extending in the circumference direction for transferring a lubrication fluid 25 between the first and second gearbox parts 17, 18. A lubrication system 26 is coupled to the first and second fluid paths 22, 23 and configured to circulate the lubrication fluid 25 through at least the gearbox 15.

A first axial end of the lubrication ring 20 extends into a first groove 27 in the first gearbox part 17. A second axial end of the lubrication ring 20 extends into a second groove 28 in the second gearbox part 18.

The fluid channel 24 is connected to a number of first openings arranged in a transverse wall 29 of the lubrication ring 20 for facilitating the flow of lubrication fluid 25 through the lubrication ring.

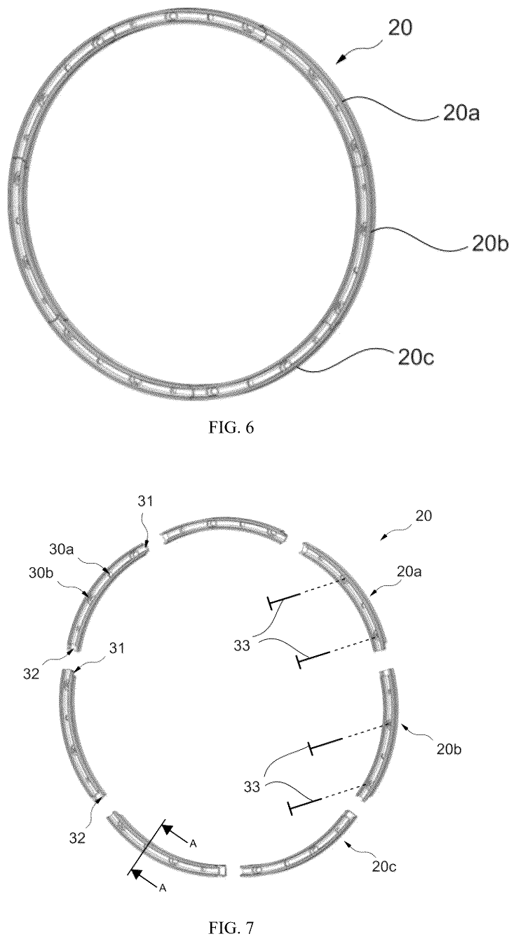

FIG. 6 shows the lubrication ring 20 in an assembly configuration. The lubrication ring 20 is formed of a plurality of ring segments 20a-20c. The lubrication ring 20 extends in a circumference direction and has a cross-sectional profile with a local radial width and a local axial height.

FIG. 7 shows the ring segments 20a-20c in an exploded configuration, where each ring segment 20a-20c has a first end 31 and a second end 32 in the circumference direction. The first end 31 of one ring segment 20a-20c is configured to be positioned relative to the second end 32 of an adjacent ring segment 20a-20c.

The ring segment 20a-20c comprises one or more openings 30a (first openings) for guiding the lubrication fluid 25 through the lubrication ring 20.

The ring segments 20a-20c further comprises one or more mounting points for securing the ring segment 20a-20c to the gearbox part 17, 18. Here, the mounting points are shaped as openings 30b, preferably oblong openings, shaped to receive fastening elements 33.

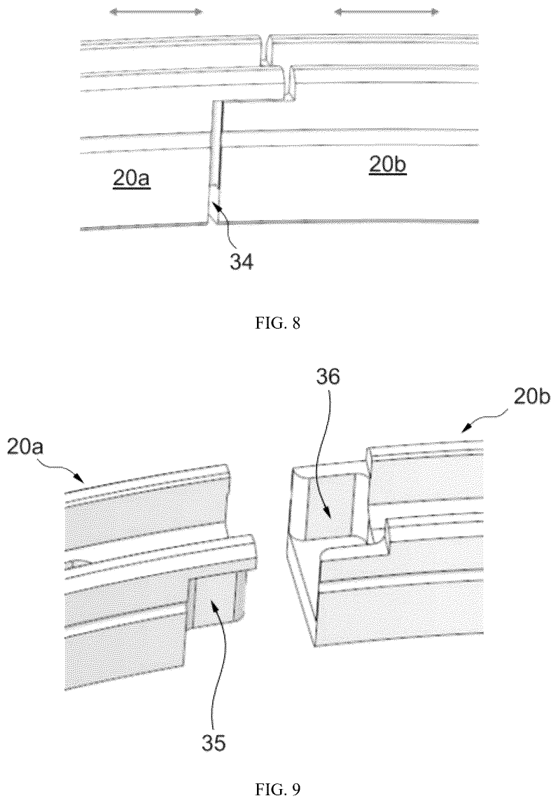

FIG. 8 shows the end interface between the first and second ring segments 20a, 20b, when assembled. A gap 34 is formed between the opposite facing first and second ends 31, 32 of the first and second ring segments 20a, 20b. The width of the gap 34 may correspond to the thermal expansion of the ring segments 20a, 20b determined at a pre-selected operating temperature. This allows the ring segments 20a-20c to expand circumferentially (indicated by arrows) when heated. The diameter of the ring segments 20a-20c may follow the thermal expansion in the radial direction.

FIG. 9 shows the first and second ring segments 20a, 20b before assembly. The first end 31 has a first connection element 35, e.g., a male element. The second end 32 has a second connection element 36, e.g., a female element. Here, the first and second connection elements 35, 36 also act as first and second sealing elements. The first and second sealing elements interlock to form a seal, preferably a labyrinth seal.

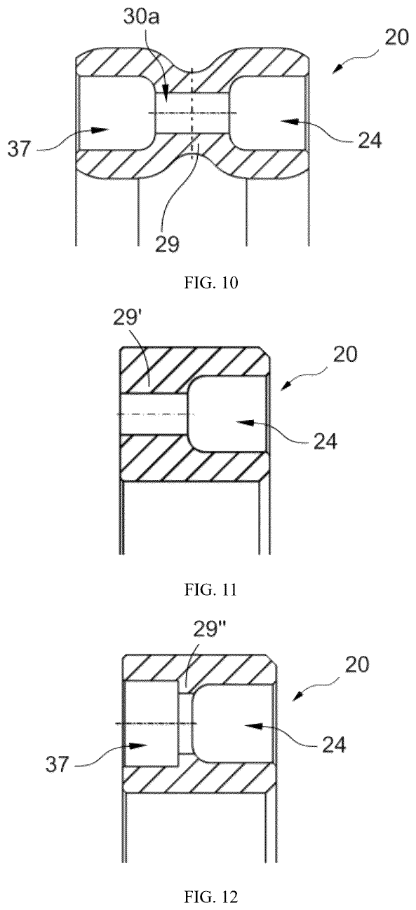

FIG. 10 shows a cross-section of the first embodiment of the lubrication ring 20. Here, the ring segment 20a-20c has a X-shaped cross-sectional profile along the A-A line shown in FIG. 7. Here, an interface for receiving the orifice element 21 at least partly is formed in the lubrication ring 20. The interface may be a recess 37 arranged at the first axial end of the ring segment 20a-20c. The opening 30a extends between the fluid channel 24 and the recess 37.

FIG. 11 shows a cross-section of the second embodiment of the of the lubrication ring 20. Here, the ring segment 20a-20c has a U-shaped cross-sectional profile along the A-A line shown in FIG. 7. Here, the first axial end has a continuous end surface for contacting the gearbox part 17, 18. The opening 30a extends between the fluid channel 24 and the axial end surface.

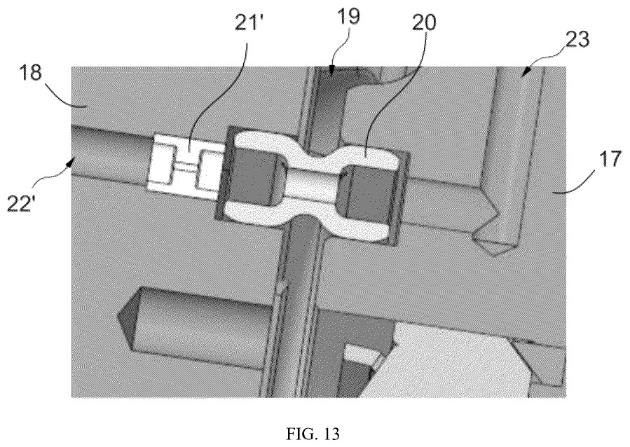

FIG. 12 shows a cross-section of the third embodiment of the of the lubrication ring 20. Here, the ring segment 20a-20c has a H-shaped cross-sectional profile along the A-A line shown in FIG. 7. Here, an interface for receiving the orifice element 21 at least partly is formed in the lubrication ring 20. The interface may be a recess 37 arranged at the first axial end of the ring segment 20a-20c. The opening 30a extends between the fluid channel 24 and the recess 37.

FIG. 13 shows a cross-section of the gearbox 15 with a third embodiment of the lubrication ring 20 according to the invention. The ring segments 20a-20c have a X-shaped cross-sectional profile, which extend partly into a first groove 27′ on the first gearbox part 17 and partly into a second groove 28 on the second gearbox part 18.

Here, the orifice element 21′ is arranged at the opening of the first fluid path 22′. The opening is located at the bottom of the first groove 27′.

1. A lubrication ring for a wind turbine gearbox (15), preferably a planetary gear box, where the lubrication ring (20) is configured to be positioned in a first gap (19) formed between a first gearbox part (17) and a second gearbox part (18), the lubrication ring (20) extending in a circumference direction and having a cross-sectional profile with a local radial thickness and a local axial height, the lubrication ring (20) forming at least one fluid channel (24) extending in the circumference direction for transferring a lubrication fluid (25) between the first and second gearbox parts (17, 18), the fluid channel (24) being connected to at least one first opening (30a) arranged in a transverse wall (29) of the lubrication ring (20) for facilitating the flow of lubrication fluid (25) through the lubrication ring (20), wherein the lubrication ring (20) comprises a number of ring segments (20a-c), each having a local first end (31) and a local opposite second end (32) in the circumference direction, the first end (31) of one ring segment is adapted to be arranged relative to the second end (32) of an adjacent ring segment.

2. The lubrication ring according to claim 1, wherein, when assembled, a second gap (34) is formed between the first end (31) of the one ring segment and the second end (32) of the adjacent ring segment, where the ring segments (20a-c) are adapted to expand towards each other in the circumference direction, when heated.

3. The lubrication ring according to claim 1, wherein the first end (31) has a first connection element (35) and the second end (32) has a second connection element (36), where the first and second connection elements (35, 36) are adapted to engage each other, when assembled.

4. The lubrication ring according to claim 2, wherein the first and second connection elements (35, 36) together form a labyrinth seal in the axial direction, the radial direction and/or the circumference direction.

5. The lubrication ring according to claim 1, wherein the ring segments (20a-c) have a U-, H- or X-shaped cross-sectional profile.

6. The lubrication ring according to claim 1, wherein the lubrication ring (20) further comprises at least one mounting point for securing the lubrication ring (20) to the first or second gearbox part (17, 18), preferably the lubrication ring (20) is adapted to move relative to the at least one mounting point in the circumference direction, when expanding.

7. The lubrication ring according claim 6, wherein the mounting point comprises an oblong opening (30b) in the transverse wall (29) adapted to receive a fastening element (33) for securing the lubrication ring (20).

8. The lubrication ring according to claim 1, wherein the ring segments (20a-c) are made of a plastic material, a ferrous metal or metal alloy, or a non-ferrous metal or metal alloy.

9. A wind turbine gearbox comprises a first gearbox part (17) and a second gearbox part (18), wherein a first gap (19) is formed between the first and second gearbox parts (17, 18), an internal or external lubrication system (26) is connected to the first gap (19) for circulating a lubrication fluid (25) between the first gearbox part (17) and the second gearbox part (18), wherein a lubrication ring (20) according to claim 1 is positioned in the first gap (19).

10. The wind turbine gearbox according to claim 9, wherein the lubrication ring (20) is secured to a gearbox housing or a planet carrier in the gearbox (15).

11. The wind turbine gearbox according to claim 9, wherein at least one fluid path (22, 23) is arranged within at least one of the first and second gearbox parts (17, 18) and further connected to the first gap (19), wherein a nozzle or orifice element (21) is arranged at an opening of the at least one fluid path (22), the opening facing the first gap (19).

12. A method of assembling a wind turbine gearbox (15), comprising:
providing a wind turbine gearbox (15) comprising at least a first gearbox part (17) and a second gearbox part (18),
positioning a first ring segment (20a) on one gearbox part (17, 18), optionally in a first groove (27, 27′),
securing the first ring segment (20a) to the one gearbox part (17, 18),
positioning at least a second ring segment (20b) relative to the first ring segment (20a),
securing the second ring segment (20b) to the one gearbox part (17, 18),
optionally, positioning further ring segments (20c) relative to the first or second ring segment (20a, 20b) and securing the further ring segments (20c) to the one gearbox part (17,18) until the assembly of the lubrication ring (20) is complete.

13. The method according to claim 12, wherein prior to positioning one or more of the ring segments (20a-c), a nozzle or orifice element (21) is arranged at an opening of at least one fluid path (22, 23) in the one gearbox part (17, 18), where the one or more ring segments (20a-c) are positioned relative to the at least one fluid path (22).

14. The method according to claim 12, wherein the method further comprises the step of positioning the first and second gearbox parts (17, 18) relative to each other so that a first gap (19) is formed between the first and second gearbox parts (17, 18), preferably the lubrication ring (20) extends into a second groove (28) in the opposite gearbox part (17, 18).
